(19) United States
(12) Patent Application Publication
(10) Pub. No.: US 2010/0118986 A1
(43) Pub. Date: May 13, 2010

(54) ACKNOWLEDGEMENT METHOD AND APPARATUS OF AGGREGATED FRAME IN WIDEBAND HIGH FREQUENCY WIRELESS SYSTEM

(75) Inventors: Seung Eun HONG, Daejeon (KR); Kyeongpyo Kim, Daejeon (KR); Yong Sun Kim, Suwon-si (KR); Woo Yong Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/615,650

(22) Filed: Nov. 10, 2009

(30) Foreign Application Priority Data
Nov. 11, 2008 (KR) 10-2008-0111538
Aug. 25, 2009 (KR) 10-2009-0078696

(51) Int. Cl. H04L 27/00; G06F 11/00; H04B 7/00

(52) U.S. Cl. 375/259; 714/799; 714/E11.002; 455/69

(57) ABSTRACT

Provided are an acknowledgement (ACK) method and apparatus of an aggregated frame in a wideband high frequency wireless system. The ACK method of a destination apparatus in the wideband high frequency wireless system includes reading subframes included in an aggregated frame during a predetermined period of time when receiving the aggregated frame, and generating an ACK frame including information about a reading result of the aggregated frame during the predetermined period of time.

### CROSS-REFERENCE TO RELATED APPLICATIONS

This application claims the benefit of Korean Patent Application Nos. 10-2008-0111538, filed on Nov. 11, 2008, and 10-2009-0078696, filed on Aug. 25, 2009, in the Korean Intellectual Property Office, the disclosures of which are incorporated herein by reference.

### BACKGROUND

1. Field

Exemplary embodiments relate to an acknowledgement (ACK) method and apparatus of an aggregated frame in a wideband high frequency wireless system, and more particularly, to a method and apparatus that may adaptively configure and transmit an ACK frame when receiving an aggregated frame in a destination apparatus of a wideband high frequency wireless system.

2. Description of the Related Art

A transmission of an aggregated frame may be a method in which a plurality of frames are bundled in a single protocol header, and the bundled frames are transmitted so as to reduce a protocol overhead. The protocol header may vary for each system, however, may generally include a physical layer protocol (PHY) header and a media access control (MAC) header. The PHY header and the MAC header may be herein referred to as a frame header, and each of a plurality of frames included in the aggregated frame may be referred to as a subframe.

In a system using an ultra wideband wireless frequency, a transmission of the aggregated frame including a single frame header and a plurality of subframes may adopt different Modulation and Coding Schemes (MCSs) for each of the plurality of subframes included in the aggregated frame. In order to notify a processing method of the above described subframes, each of the plurality of subframes may have a subheader, the subheaders may be bundled to configure an MAC subheader, and the MAC subheader may be positioned immediately following the frame header.

In the transmission of the aggregated frame as described above, since different MCSs are applicable for each subframe, a reception result of a transmitted aggregated frame may differ for each subframe. In order to effectively process a re-transmission of the subframe based on the reception result, in related arts, a subframe reception result and a reception buffer size of a reception apparatus may need to be displayed in the MAC subheader.

In the related arts, an acknowledgement (ACK) frame including reception results of all subframes included in the aggregated frame may need to be transmitted in a predetermine period of time after transmitting the aggregated frame. A source apparatus may transmit the aggregated frame and simultaneously drive a timer, and may be expected to receive, using the ACK frame, the reception results of all subframes included in the transmitted aggregated frame before the timer is terminated. When the reception apparatus fails to receive the ACK frame until the timer is terminated, it may be determined that the all subframes included in the transmitted aggregated frame are not properly transmitted, and the all subframes may be re-transmitted.

Also, in the related arts, a significant stringent standard may be applied in a frame reception process of a destination apparatus, such that the destination apparatus needs to transmit the reception results with respect to the all subframes, included in the aggregated frame received from the source apparatus, immediately after a predetermined period of time. That is, the destination apparatus may need to perform a demodulation of the received aggregated frame and a channel decoding within a predetermined period of time, to determine reception results with respect to subframes to configure an ACK frame, and then to transmit the ACK frame to the source apparatus. When a significant amount of time is taken in a reception process as in a complex channel decoding scheme, it may be impossible for the destination apparatus to transmit the ACK frame within the predetermined period of time, which may continuously induce the source apparatus to re-transmit the aggregated frame, resulting in a deterioration in a system performance.

### SUMMARY

An aspect of exemplary embodiments provides an acknowledgement (ACK) method and apparatus of an aggregated frame in a wideband high frequency wireless system.

An aspect of exemplary embodiment also provides a method and apparatus that may adaptively configure and transmit an ACK frame when receiving an aggregated frame in a destination apparatus of a wideband high frequency wireless system.

An aspect of exemplary embodiment also provides a method and apparatus that may configure and transmit, when receiving an aggregated frame in a destination apparatus of a wideband high frequency wireless system, an ACK frame including only ACK results with respect to subframes of which a reception process is terminated, instead of reception results with respect to all subframes included in the received aggregated frame.

According to an aspect of exemplary embodiments, there is provided an acknowledgement (ACK) method of an aggregated frame in a destination apparatus of a wideband high frequency wireless system, the ACK method including: reading subframes included in an aggregated frame during a predetermined period of time when receiving the aggregated frame; and generating an ACK frame including information about a reading result of the aggregated frame during the predetermined period of time.

According to another aspect of exemplary embodiments, there is provided a method of transmitting an aggregated frame in a source apparatus of a wideband high frequency wireless system, the method including: generating an aggregated frame including a plurality of subframes, and transmitting the generated aggregated frame; receiving an ACK frame including a reading result obtained by reading the aggregated frame during a predetermined period of time; reading the ACK frame; and generating a subsequent aggregated frame including a subframe in which an error occurs in the ACK frame when information about the subframe is present according to the reading result.

According to still another aspect of exemplary embodiments, there is provided a destination apparatus of acknowledging an aggregated frame in a wideband high frequency wireless system, the destination apparatus including: an aggregated frame reading unit to read subframes included in an aggregated frame during a predetermined period of time when receiving the aggregated frame; and an ACK frame generation unit to generate an ACK frame including information about a reading result of the aggregated frame during the predetermined period of time.

According to yet another aspect of exemplary embodiments, there is provided a source apparatus of transmitting an aggregated frame in a wideband high frequency wireless system, the source apparatus including: an ACK frame reading unit to receive an ACK frame including a reading result obtaining by reading an aggregated frame during a predetermined period of time and to read the ACK frame; and an aggregated frame generation unit to generate and transmit the aggregated frame including a plurality of subframes, and to generate a subsequent aggregated frame including a subframe in which an error occurs in the ACK frame when information about the subframe is present according to the reading result.

### EFFECT

According to exemplary embodiments, there are provided a method and apparatus that may configure and transmit, when receiving an aggregated frame in a destination apparatus of a wideband high frequency wireless system, an ACK frame including only ACK results with respect to subframes of which a reception process is terminated, instead of reception results with respect to all subframes included in the received aggregated frame, thereby reducing a re-transmission of the aggregated frame, resulting in a reduction of a waste of resources.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 illustrates a configuration of a destination apparatus generating and transmitting an acknowledgement (ACK) frame and of a source apparatus transmitting an aggregated frame in a wideband high frequency wireless system according to exemplary embodiments;

FIG. 2 illustrates a format of an ACK frame with respect to an aggregated frame generated in a destination apparatus of a wideband high frequency wireless system according to exemplary embodiments;

FIG. 3 illustrates an example of transmitting/receiving an ACK frame with respect to an aggregated frame in a wideband high frequency wireless system according to exemplary embodiments;

FIG. 4 is a flowchart illustrating a process of transmitting an aggregated frame and receiving an ACK frame in a source apparatus of a wideband high frequency wireless system according to exemplary embodiments; and

FIG. 5 is a flowchart illustrating a process of receiving an aggregated frame and transmitting an ACK frame in a destination apparatus of a wideband high frequency wireless system according to exemplary embodiments.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

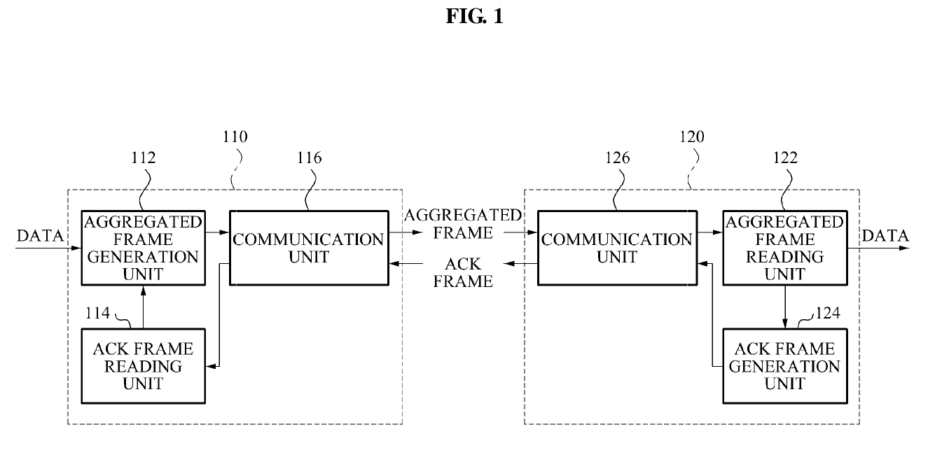

Exemplary embodiments relate to a method and apparatus that may adaptively configure and transmit an acknowledgement (ACK) frame when receiving an aggregated frame in a destination apparatus of a wideband high frequency wireless system. A configuration of a source apparatus and the destination apparatus will be described herein in detail with reference to FIG. 1.

FIG. 1 illustrates a configuration of a destination apparatus 120 generating and transmitting an ACK frame and of a source apparatus 110 transmitting an aggregated frame in a wideband high frequency wireless system according to exemplary embodiments.

Referring to FIG. 1, the wideband high frequency wireless system of an exemplary embodiment includes the source apparatus 110 transmitting an aggregated frame, and the destination apparatus 120 transmitting an ACK frame when receiving the aggregated frame.

Here, the source apparatus 110 includes an aggregated frame generation unit 112, an ACK frame reading unit 114, and a communication unit 116. The destination apparatus 120 includes an aggregated frame reading unit 122, an ACK frame generation unit 124, and a communication unit 126.

The communication unit 116 of the source apparatus 110 and the communication unit 126 of the destination apparatus 120 may support communications of the source apparatus 110 and the destination apparatus 120 to transmit/receive the aggregated frame and the ACK frame.

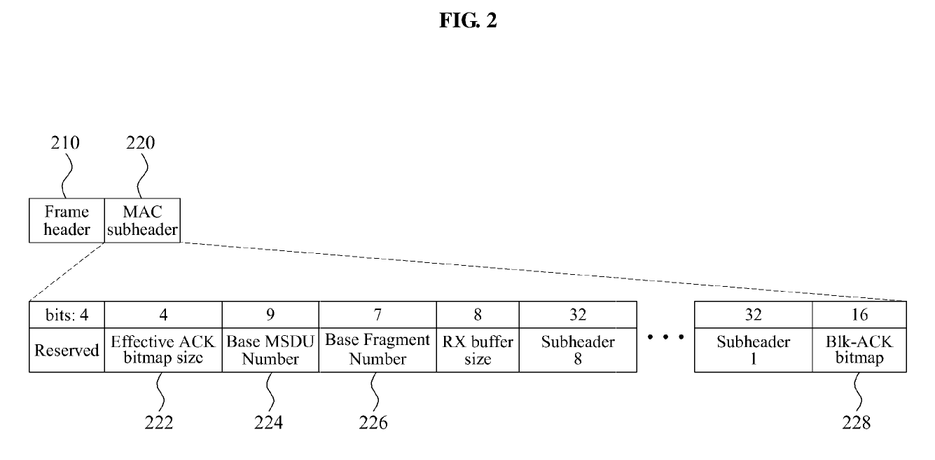

The aggregated frame generation unit 112 of the source apparatus 110 may generate the aggregated frame including a plurality of subframes, and transmit the generated aggregated frame to the destination apparatus 120 through the communication unit 116. When failing to receive the ACK frame within a predetermined period of time, the aggregated frame generation unit 112 may re-transmit the aggregated frame. Also, the aggregated frame generation unit 112 may enable an erroneous subframe, in which an error occurs, to be included at the time of generating a subsequent aggregated frame when receiving information about the erroneous subframe using the ACK frame reading unit 114. The ACK frame reading unit 114 of the source apparatus 110 may read the ACK frame when receiving the ACK frame, verify information about a subframe having been read in the destination apparatus 120, and provide, to the aggregated frame generation unit 112, the information about the erroneous subframe. Here, the received ACK frame may include an effective ACK bitmap size, a base media access control (MAC) Service Data Unit (MSDU) number field, a base fragment number field, and an ACK bitmap field. Detailed description of the ACK frame will be made with reference to FIG. 2.

The aggregated frame reading unit 122 of the destination apparatus 120 may read subframes included in the aggregated frame when receiving the aggregated frame. The reading of the aggregated frame reading unit 122 may denote verifying the included subframes, verifying an error occurrence/nonoccurrence of the subframes, and outputting the subframes in which an error does not occur. In this instance, the aggregated frame reading unit 122 may provide, to the ACK frame generation unit 124, the read information and information about the erroneous subframe in which the error occurs.

The ACK frame generation unit 124 of the destination apparatus 120 may generate an ACK frame including information about reading results up to the subframe having been read during a predetermined period of time in the aggregated frame reading unit 122, and transmit the generated ACK frame to the source apparatus 110 using the communication unit 126. Here, the ACK frame may include an effective ACK bitmap size field, a base MSDU number field, a base fragment number field, and an ACK bitmap field.

FIG. 2 illustrates a format of an ACK frame with respect to an aggregated frame generated in a destination apparatus of a wideband high frequency wireless system according to exemplary embodiments.

Referring to FIG. 2, the ACK frame according to an exemplary embodiment may include a frame header 210 and an MAC subheader 220. The MAC subheader 220 may include an effective ACK bitmap size field 222, a base MSDU number field, and a base fragment number field 226 as well as conventional fields.

The effective ACK bitmap size field 222, the base MSDU number field 224, and the base fragment number field 226 may be assigned using a reserved field of 3 bytes unused in a conventional MAC subheader.

The effective ACK bitmap size field 222 may express an effective bitmap size in an ACK bitmap field 228. For example, when a value of the effective ACK bitmap size field 222 is zero, it may denote that a subframe having been read during a predetermined period of time is absent even though the aggregated frame is received. If the value of the effective ACK bitmap size field 222 is ‘4’, it may denote that a reception process and a verification process of error occurrence/nonoccurrence, up to four subframes including a subframe designated by the base MSDU number field 224 and the base fragment number field 226, are terminated.

The ACK bitmap field 228 may be a field in which the error occurrence/nonoccurrence of the read subframe is displayed as ‘1’ or ‘0’.

The base MSDU number field 224 may display an MSDU number of a subframe corresponding to a first bit of the ACK bitmap field. That is, the base MSDU number field 224 may be an MSDU number of a final subframe in which an error does not occur from among the subframes having been read in the received aggregated frame.

The base fragment number field 226 may display a fragment number of a subframe corresponding to a first bit of the ACK bitmap field. That is, the base fragment number field 226 may be a fragment number of the final subframe in which the error does not occur from among the subframes having been read in the received aggregated frame.

The effective ACK bitmap size field 222 may be configured to occupy a 4-bit space in order to display a bitmap effective bit number ranging from ‘0’ to ‘8’. The base MSDU number field 224 may be configured to occupy a 9-bit space such as a space used by a number of bits in an MSDU field used in a conventional art. The base fragment number field 226 may be configured to occupy a 7-bit space such as a space used by a number of bits in a fragment number field used in the conventional art.

In FIG. 2, a part of a reserved field may be assigned and used in the base MSDU number field 224 and the base fragment number field 226, however, the part of the reserved field may be assigned only in the ACK bitmap size field 222, and the base MSDU number field 224 and the base fragment number field 226 may re-use the MSDU number field and fragment number field of the MAC header included in the frame header 210. The MSDU number field and fragment number field of the MAC header existing within the frame header 210 may be a field perpetually existing, however, may be used as an application for displaying information about data payloads, and thus may be re-used as another application in a case where the data payload is absent similar to the ACK frame.

That is, in the ACK frame, the MSDU number field of the MAC header existing within the frame header 210 may be re-used as the base MSDU number field, and the fragment number field of the MAC header may be re-used as the base fragment number field.

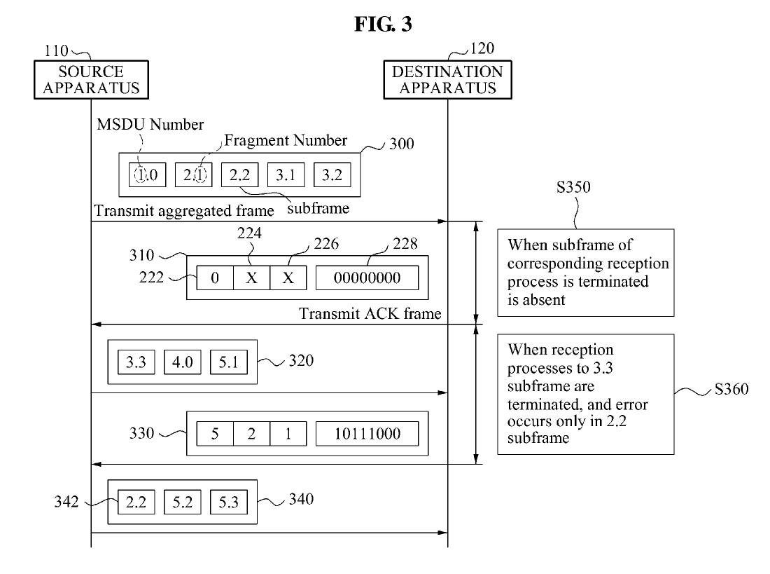

FIG. 3 illustrates an example of transmitting/receiving an ACK frame with respect to an aggregated frame in a wideband high frequency wireless system according to exemplary embodiments.

Referring to FIG. 3, the source apparatus 110 may transmit, to the destination apparatus 150, an aggregated frame 300 including five subframes. The five subframes included in the transmitted aggregated frame 300 may be a first MSDU, fragment frames in which a second MSDU is divided into two, and fragment frames in which a third MSDU is divided into two.

The destination apparatus 120 receiving the aggregated frame 300 including the five subframes may be in a state where a subframe having been read in the aggregated frame 300 during a predetermined period of time is absent in operation S350.

Accordingly, the destination apparatus 120 may designate the effective ACK bitmap size field 222 as ‘0’ in the ACK frame, and transmit an ACK frame 310 to the source apparatus 110. When the effective ACK bitmap size is zero, the base MSDU number field 224, the base fragment field 226, and the ACK bitmap field 228 may be meaningless.

In a case of an ACK frame of a conventional art, all bitmap fields may be designated as ‘0’. Accordingly, the source apparatus may regard that all subframes within the transmitted aggregated frame fail to be transmitted, and thereby may re-transmit all subframes.

However, the source apparatus according to an exemplary embodiment may additionally bundle together a final division fragment frame of a third MSDU, a fourth MSDU, and a first division fragment frame of a fifth MSDU instead of re-transmitting previously transmitted subframes of the aggregated frame, when receiving the ACK frame 310, and transmit the bundled frames to the destination apparatus 120.

The destination apparatus 120 receiving a second aggregated frame 320 may terminate processing to read up to a final division fragment frame of the third MSDU in operation S360 before transmitting a second ACK frame 330, and may recognize that an error occurs only in a second division fragment frame of the second MSDU from among the fragment frames having been read according to the reading result.

In this case, in order to report that up to a first fragment frame of the second MSDU in the second ACK frame 330 are successfully received, the destination apparatus 120 may designate a value of the base MSDU field 224 as ‘2’, and a value of the base fragment field 226 as ‘1’. Also, the destination apparatus 120 may display, using the bitmap field, reception results with respect to a total of five subframes ranging from a subframe designated by the base MSDU field 222 and the base fragment field 224 to a third fragment frame of the third MSDU of which a reception is terminated. In this instance, since a size of the effective bitmap field is ‘5’, a value of the effective bitmap size field 222 of the second ACK frame 330 may be designated as ‘5’.

Then, the source apparatus 110 receiving the second ACK frame 330 may generate an aggregated frame 340 including a subframe 342 indicating a second fragment of the second MSDU, that is, an erroneous frame in which an error occurs.

A method of generating and transmitting an ACK frame with respect to a transmitted aggregated frame in a wideband high frequency wireless system according to an exemplary embodiment configured as described above will be herein described in detail with reference to drawings.

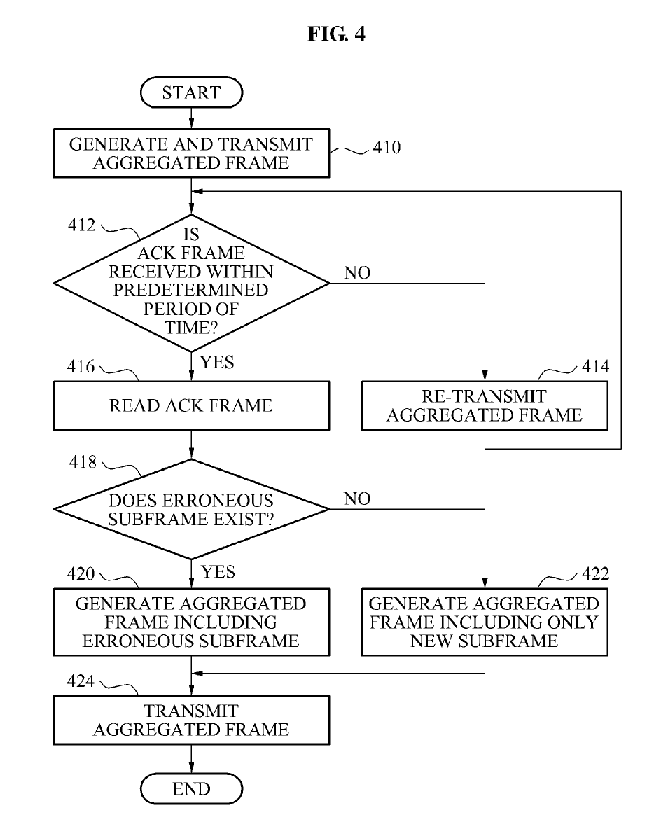

FIG. 4 is a flowchart illustrating a process of transmitting an aggregated frame and receiving an ACK frame in a source apparatus of a wideband high frequency wireless system according to exemplary embodiments.

Referring to FIG. 4, the source apparatus according to an exemplary embodiment may generate and transmit an aggregated frame including a plurality of subframes in operation 410. In operation 412, the source apparatus may verify whether an ACK frame with respect to the transmitted aggregated frame is received during a predetermined period of time.

In operation 414, the source apparatus may re-transmit the aggregated frame when the ACK frame is not received according to the verified result of operation 412. In operation 416, the source apparatus may read the received ACK frame when the ACK frame is received according to the verified result of operation 412.

Here, the received ACK frame may be an ACK frame including the reading result obtaining by reading all subframes included in the aggregated frame in a similar manner as described with reference to FIG. 2, however, may be an ACK frame only including reading results up to a subframe having been read during the predetermined period of time. The ACK frame may include an effective ACK bitmap size field, a base MSDU number field, a base fragment number field, and an ACK bitmap field.

In operation 418, the source apparatus may verify whether an erroneous frame is present in the transmitted aggregated frame according to the reading result.

In operation 420, the source apparatus may generate an aggregated frame including the erroneous subframe at the time of generation of a subsequent aggregated frame, proceed to operation 424, and transmit the generated aggregated frame. However, when the erroneous frame is absent according to the verified result of operation 418, the source apparatus may generate a subsequent aggregated frame including new subframes in operation 422, and transmit the generated aggregated frame in operation 424.

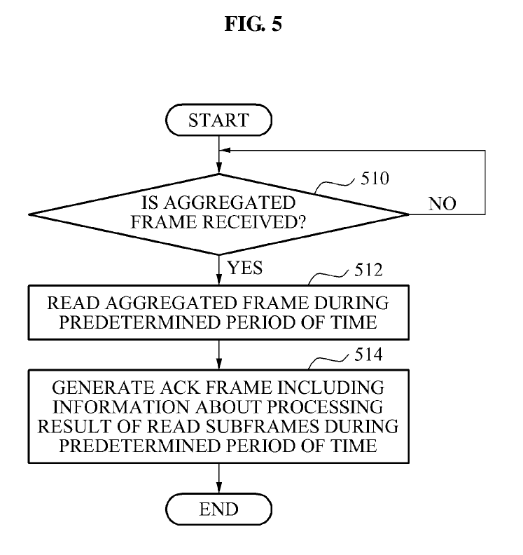

FIG. 5 is a flowchart illustrating a process of receiving an aggregated frame and transmitting an ACK frame in a destination apparatus of a wideband high frequency wireless system according to exemplary embodiments.

Referring to FIG. 5, the destination apparatus according to an exemplary embodiment may proceed to operation 512 after receiving an aggregated frame in operation 510, and read the aggregated frame during a predetermined period of time. In operation 514, the destination apparatus may generate an ACK frame including information about the reading results up to a subframe having been read during the predetermined period of time, and transmit the generated ACK frame to the source apparatus. Here, the ACK frame may include an effective ACK bitmap size field, a base MSDU number field, a base fragment number field, and an ACK bitmap field.

The above described methods may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. An acknowledgement (ACK) method of an aggregated frame in a destination apparatus of a wideband high frequency wireless system, the ACK method comprising:
reading subframes included in an aggregated frame during a predetermined period of time when receiving the aggregated frame; and
generating an ACK frame including information about a reading result of the aggregated frame during the predetermined period of time.

2. The ACK method of claim 1, wherein the generating enables information indicating absence of a read subframe to be included in the ACK frame to thereby transmit the included information, when the read subframe is absent according to the reading result of the aggregated frame during the predetermined period of time.

3. The ACK method of claim 1, wherein the ACK frame includes an ACK bitmap field indicating error occurrence/nonoccurrence of the subframes, an effective ACK bitmap size field indicating a size of an effective bitmap in the ACK bitmap field, a base media access control (MAC) Service Data Unit (MSDU) number field indicating an MSDU number of a subframe corresponding to a first bit of the ACK bitmap field, and a base fragment number field indicating a fragment number of the subframe corresponding to the ACK bitmap field.

4. The ACK method of claim 3, wherein the generating displays information indicating absence of a read subframe in the effective ACK bitmap size field when the read subframe is absent according to the reading result of the aggregated frame during the predetermined period of time.

5. The ACK method of claim 3, wherein the ACK frame includes an MAC subheader, and the MAC subheader includes the ACK bitmap field, the effective ACK bitmap size field, the base MSDU number field, and the base fragment number field.

6. The ACK method of claim 3, wherein the ACK frame includes a frame header and an MAC subheader, the frame header includes the base MSDU number field and the base fragment number field, and the MAC subheader includes the ACK bitmap field and the effective ACK bitmap size field.

7. A method of transmitting an aggregated frame in a source apparatus of a wideband high frequency wireless system, the method comprising:
generating an aggregated frame including a plurality of subframes, and transmitting the generated aggregated frame;
receiving an ACK frame including a reading result obtained by reading the aggregated frame during a predetermined period of time;
reading the ACK frame; and
generating a subsequent aggregated frame including a subframe in which an error occurs in the ACK frame when information about the subframe is present according to the reading result.

8. The method of claim 7, wherein the ACK frame includes an ACK bitmap field indicating error occurrence/nonoccurrence of the subframes, an effective ACK bitmap size field indicating a size of an effective bitmap in the ACK bitmap field, a base MSDU number field indicating an MSDU number of a subframe corresponding to a first bit of the ACK bitmap field, and a base fragment number field indicating a fragment number of the subframe corresponding to the ACK bitmap field.

9. A destination apparatus of acknowledging an aggregated frame in a wideband high frequency wireless system, the destination apparatus comprising:
an aggregated frame reading unit to read subframes included in an aggregated frame during a predetermined period of time when receiving the aggregated frame; and
an ACK frame generation unit to generate an ACK frame including information about a reading result of the aggregated frame during the predetermined period of time.

10. The destination apparatus of claim 9, wherein the ACK frame generation unit enables information indicating absence of a read subframe to be included in the ACK frame to thereby transmit the ACK frame, when the read subframe is absent according to the reading result of the aggregated frame during the predetermined period of time.

11. The destination apparatus of claim 9, wherein the ACK frame includes an ACK bitmap field indicating error occurrence/nonoccurrence of the subframes, an effective ACK bitmap size field indicating a size of an effective bitmap in the ACK bitmap field, a base MSDU number field indicating an MSDU number of a subframe corresponding to a first bit of the ACK bitmap field, and a base fragment number field indicating a fragment number of the subframe corresponding to the ACK bitmap field.

12. The destination apparatus of claim 11, wherein the ACK frame generation unit displays information indicating absence of a read subframe in the effective ACK bitmap size field when the read subframe is absent according to the reading result of the aggregated frame during the predetermined period of time.

13. The destination apparatus of claim 11, wherein the ACK frame includes an MAC subheader, and the MAC subheader includes the ACK bitmap field, the effective ACK bitmap size field, the base MSDU number field, and the base fragment number field.

14. The destination apparatus of claim 11, wherein the ACK frame includes a frame header and an MAC subheader, the frame header includes the base MSDU number field and the base fragment number field, and the MAC subheader includes the ACK bitmap field and the effective ACK bitmap size field.

15. A source apparatus of transmitting an aggregated frame in a wideband high frequency wireless system, the source apparatus comprising:
an ACK frame reading unit to receive an ACK frame including a reading result obtaining by reading an aggregated frame during a predetermined period of time and to read the ACK frame; and
an aggregated frame generation unit to generate and transmit the aggregated frame including a plurality of subframes, and to generate a subsequent aggregated frame including a subframe in which an error occurs in the ACK frame when information about the subframe is present according to the reading result.

16. The source apparatus of claim 15, wherein the ACK frame includes an ACK bitmap field indicating error occurrence/nonoccurrence of the subframes, an effective ACK bitmap size field indicating a size of an effective bitmap in the ACK bitmap field, a base MSDU number field indicating an MSDU number of a subframe corresponding to a first bit of the ACK bitmap field, and a base fragment number field indicating a fragment number of the subframe corresponding to the ACK bitmap field.
